(19) United States
(12) Patent Application Publication
(10) Pub. No.: US 2009/0046084 A1
(43) Pub. Date: Feb. 19, 2009

(54) GATE-DRIVING CIRCUIT AND DISPLAY APPARATUS INCLUDING THE SAME

(76) Inventor: Myong-Bin Lim, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 12/185,664

(22) Filed: Aug. 4, 2008

(30) Foreign Application Priority Data
Aug. 17, 2007 (KR) 10-2007-0082799

(51) Int. Cl. G06F 3/038

(52) U.S. Cl. 345/205

(57) ABSTRACT

A gate-driving circuit operating in a stable manner even when simultaneously driving a plurality of gate lines at high levels is provided. The gate-driving circuit includes a shift register that receives a gate clock signal and scanning start signal and/or a mode signal and sequentially provides a plurality of pre-gate signals in synchronization with the gate clock signal, an operation section that receives the gate clock signal and the plurality of pre-gate signals and performs operations on the plurality of pre-gate signals which includes sequentially outputting a plurality of operation signals and a selector receives the plurality of pre-gate signals and the plurality of operation signals and selectively outputs the plurality of pre-gate signals or the plurality of operation signals in response to receipt of the mode signal.

### CROSS-REFERENCE TO RELATED APPLICATION

This application claims priority from Korean Patent Application No. 10-2007-0082799 filed on Aug. 17, 2007 in the Korean Intellectual Property Office, the disclosure of which is incorporated herein by reference in its entirety.

### BACKGROUND OF THE INVENTION

1. Field of the Invention

The present invention relates to a gate-driving circuit, and, more particularly, to a gate-driving circuit operating in a stable manner even when simultaneously driving a plurality of gate lines at high voltage levels.

2. Description of the Related Art

Recently, flat panel displays, such as organic light emitting diode (“OLED”) displays, plasma display panels (“PDPs”), and liquid crystal displays (“LCDs”) have been developed, and are replacing previous displays employing, for example, heavy and large cathode ray tubes (“CRTs”).

Generally, a liquid crystal display device includes an upper panel on which a common electrode, color filters, black matrixes, and so on, are formed, a lower panel on which thin film transistors (TFTs), pixel electrodes, are formed, and a liquid crystal layer disposed between the upper and lower panels. And LCD further complies driving apparatus which drives the upper and lower panels, complies gate-driving circuit. Upon application of a potential difference between the pixel electrodes and the common electrode, an electric field is generated in the liquid crystal layer, and the orientation of liquid crystals is determined on the basis of the electric field. Since the transmittance of incident light is a function of the alignment of liquid crystal molecules, it is possible to display a desired image by adjusting the potential difference between the two electrodes.

The display circuit, a gate-driving circuit generates gate-on voltages (Von) which are sequentially applied to gate lines for each clock period of the gate clock signals. However, when gate-on voltages (Von) are simultaneously applied to a plurality of gate lines, for example for the purpose of achieving ensured panel driving reliability within a short time, the gate-driving circuit may not operate in a stable manner.

### SUMMARY OF THE INVENTION

The present invention provides a gate-driving circuit which operates in a stable manner even when simultaneously driving a plurality of gate lines at high voltage levels including gate-on voltages.

The present invention also provides a display circuit operating in a stable manner even when simultaneously driving a plurality of gate lines at high voltage levels including gate-on voltages.

The present invention also provides a method of driving a display circuit operating in a stable manner even when simultaneously driving a plurality of gate lines at high voltage levels including gate-on voltages.

The above and other features of the present invention are described in or will be apparent from the following description of the preferred embodiments.

According to one aspect of the present invention, there is provided a gate-driving circuit including a shift register that receives a gate clock signal and scanning start signal and/or a mode signal and sequentially provides a plurality of pre-gate signals in synchronization with the gate clock signal, an operation section that receives the gate clock signal and the plurality of pre-gate signals and performs operations on the plurality of pre-gate signals which includes sequentially outputting a plurality of operation signals and a selector receives the plurality of pre-gate signals and the plurality of operation signals and selectively outputs the plurality of pre-gate signals or the plurality of operation signals in response to receipt of the mode signal.

According to still another aspect of the present invention, there is provided a display device including a display panel that includes a plurality of unit displays defined at intersections of a plurality of gate lines and a plurality of data lines a timing controller that generates various control signals for driving the plurality of unit displays, a driving voltage generator that receives the control signals and generates a plurality of driving voltages, a gate driving circuit comprising, a shift register that receives a scanning start signal and a gate clock signal and/or a mode signal and sequentially provides a plurality of pre-gate signals in synchronization with the gate clock signal, an operation section that receives the gate clock signal and the plurality of pre-gate signals and performs operations on the plurality of pre-gate signals which includes sequentially outputting a plurality of operation signals, and a selector receives the plurality of pre-gate signals and the plurality of operation signals and selectively outputs the plurality of pre-gate signals or the plurality of operation signals in response to receipt of the mode signal and a data driver that supplies data voltages to the plurality of data lines

According to a further aspect of the present invention, there is provided a method of driving a display device including providing a shift register with a scanning start signal and/or a mode signal and to sequentially provide a plurality of pre-gate signals in synchronization with a gate clock signal, providing an operation on the plurality of pre-gate signals and the gate clock signal, respectively, and to sequentially output a plurality of operation signals, selectively outputting the plurality of pre-gate signals or the plurality of operation signals in response to the mode signal and using the pre-gate signals or the operation signals in a display of an image

### BRIEF DESCRIPTION OF THE DRAWINGS

The above and other features and advantages of the present invention will become apparent by describing in detail preferred embodiments thereof with reference to the attached drawings in which:

FIG. 1 is a block diagram of a gate-driving circuit according to a first embodiment of the present invention;

FIG. 2 illustrates various stages of the gate-driving circuit shown in FIG. 1;

FIG. 3 is an exemplary block diagram of a shift register suitable for use in the gate-driving circuit shown in FIG. 1;

FIGS. 4A through 4C illustrates various stages of the gate-driving circuit shown in FIG. 1;

FIG. 5 is a timing diagram illustrating signals used in the operation of the gate-driving circuit shown in FIG. 1;

FIG. 6 is a block diagram of a gate-driving circuit according to a second embodiment of the present invention;

FIG. 7A is a block diagram of the mode selector shown in FIG. 6;

FIG. 7B is a timing diagram of signals used to operate the mode selector;

FIG. 7C is a block diagram of counter 142 shown in FIG. 7A;

FIG. 7D is a timing diagram for the second embodiment;

FIG. 8 is a block diagram illustrating a display device according to embodiments of the present invention;

FIG. 9 is an equivalent circuit diagram of one pixel in the display device shown in FIG. 8; and

FIGS. 10A and 10B illustrate simulated results of the operation of a gate-driving circuit according to an exemplary embodiment of the present invention.

### DETAILED DESCRIPTION OF THE INVENTION

Advantages and features of the present invention and methods of accomplishing the same will be understood more readily by reference to the following detailed description of preferred embodiments and the accompanying drawings. The present invention may, however, be embodied in many different forms and should not be construed as being limited to the embodiments set forth herein. Rather, these embodiments are provided so this disclosure will be thorough and complete and will fully convey the concept of the invention to those skilled in the art. The scope of the present invention is only to be defined by the appended claims. Like reference numerals refer to like elements throughout the specification.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items.

It will be understood that, although the terms first and second may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

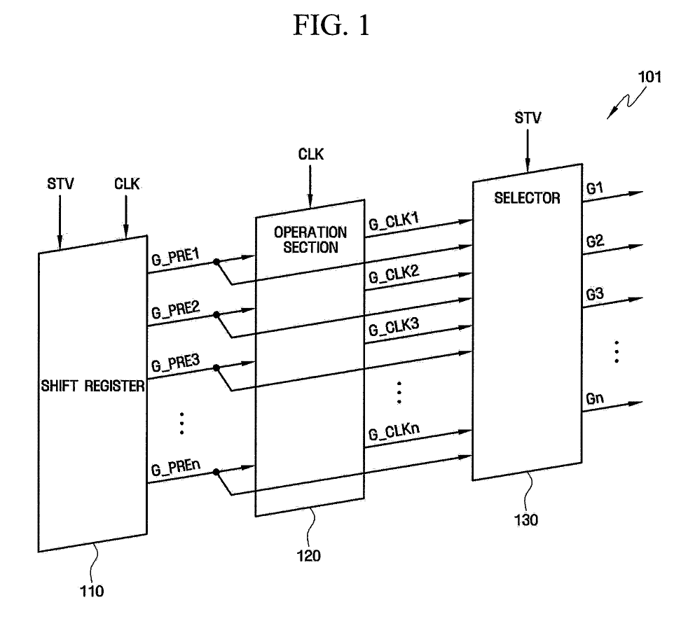

A gate-driving circuit according to an embodiment of the present invention will be described with reference to FIGS. 1 through 5. For explanatory convenience, an embodiment of the present invention will be described using a gate-driving circuit in the form of IC chips. However, it will be apparent to those skilled in the art that the gate-driving circuit may be mounted on a flexible printed circuit film or a display panel together with switching elements Q.

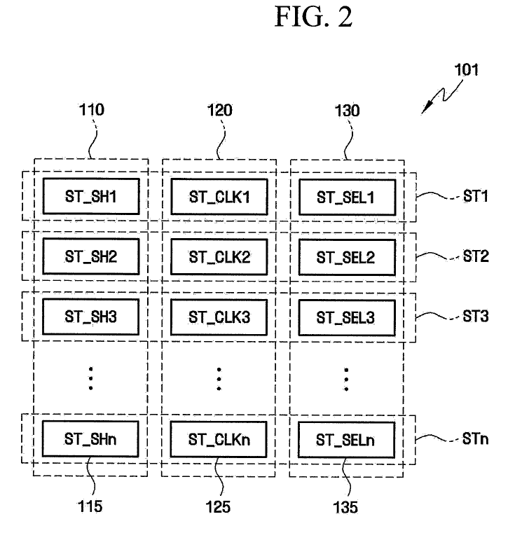

FIG. 1 is a block diagram of a gate-driving circuit according to a first embodiment of the present invention, and FIG. 2 illustrates various stages of the gate-driving circuit shown in FIG. 1.

Referring to FIGS. 1 and 2, the gate-driving circuit 101 includes a shift register 110, an operation section 120, and a selector 130.

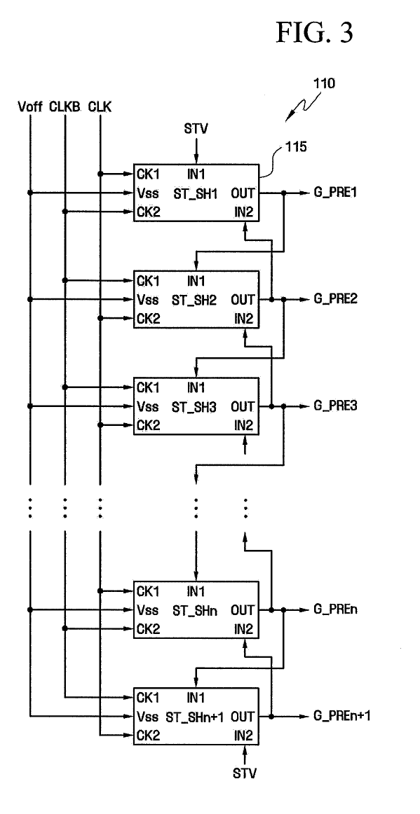

The shift register 110 receives a scanning start signal STV and sequentially provides a plurality of pre-gate signals G_PRE1˜G_PREn in synchronization with a gate clock signal CLK. The shift register 110 includes a plurality of shifting stages ST_SH1˜ST_SHn connected in cascade which sequentially outputs the pre-gate signals G_PRE1˜G_PREn. Detailed operation of the shift register 110 is described below with reference to FIG. 3.

The operation section 120 performs operations on the plurality of pre-gate signals G_PRE1˜G_PREn and the gate clock signal CLK, respectively, and sequentially outputs a plurality of operation signals G_CLK1˜G_CLKn. The operation section 120 may include a plurality of operation stages ST_CLK1˜ST_CLKn which receive the gate clock signal CLK and the plurality of pre-gate signals G_PRE1˜G_PREn, and output a plurality of operation signals G_CLK1˜G_CLKn.

The selector 130 may selectively output the plurality of pre-gate signals G_PRE1˜G_PREn or the plurality of operation signals G_CLK1˜G_CLKn in response to the scanning start signal STV. The selector 130 may include a plurality of selection stages ST_SEL1˜ST_SELn which receive the plurality of operation signals G_CLK1˜G_CLKn and the plurality of pre-gate signals G_PRE1˜G_PREn, select the plurality of operation signals G_CLK1˜G_CLKn or the plurality of pre-gate signals G_PRE1˜G_PREn in response to the scanning start signal STV, and output the selective signals as gate signals G1˜Gn.

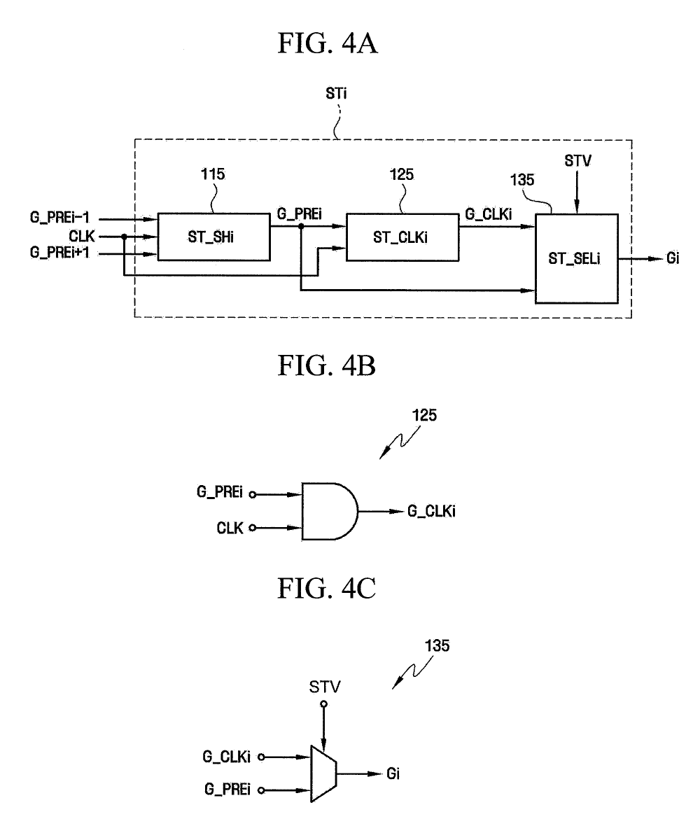

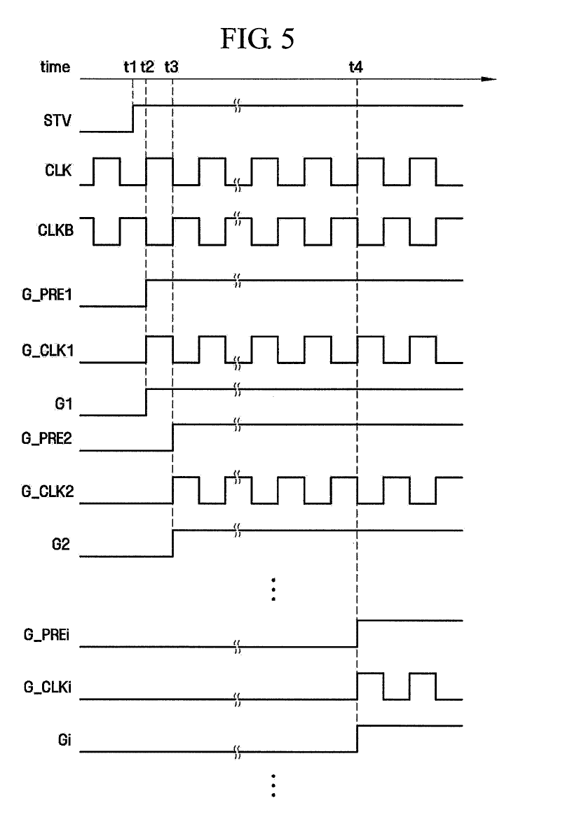

Referring to FIG. 2, the gate-driving circuit 101 may also include a plurality of stages ST1˜STn connected in cascade and sequentially outputting gate signals G1˜Gn). Each of the plurality of stages ST1˜STn, e.g., STn, may include a shifting stage (e.g., ST_SHn), an operation stage (e.g., ST_CLKn), and a selection stage (e.g., ST_SELn). The circuit and operation of each stage (e.g., STn) is described below in further detail with reference to FIGS. 4A to 5.

FIG. 3 is an exemplary block diagram of a shift register in the gate-driving circuit shown in FIG. 1.

Referring to FIG. 3, the shift register 110 may include a plurality of shifting stages ST_SH1˜ST_SHn+1 connected in cascade and sequentially outputting the pre-gate signals G_PRE1˜G_PREn+1. All the shifting stages ST_SH1˜ST_SHn, except the last shifting stage ST_SHn+1, may be connected to corresponding pairs of the plurality of operation stages ST_CLK1˜ST_CLKn of the operation section 120 and to the selection stages ST_SEL1˜ST_SELn of the selector 130, respectively. The last shifting stage ST_SHn+1 is a dummy shifting stage ST_SHn+1 outputting a dummy pre-gate signal G_PREn+1. The dummy pre-gate signal G_PREn+1 disables a previous shifting stage and may be provided to all the previous shifting stages as well as a particular shifting stage.

Each of the plurality of shifting stages ST_SH1˜ST_SHn+1 has a first clock terminal CK1, a second clock terminal CK2, a first input terminal IN1, a second input terminal IN2, a gate-off voltage terminal Vss, and a pre-gate signal output terminal OUT.

A pre-gate signal G_PRE1 outputted from a previous shifting stage, e.g., ST_SH1, may be input to the first input terminal IN1 of each shifting stage, e.g., ST_SH2, and a pre-gate signal G_PRE3 outputted from a next shifting stage, e.g., ST_SH3, may be input to the second input terminal IN2. In addition, a first clock signal CLK and a second clock signal CLKB may be input to the first clock terminal CK1 and the second clock terminal CK2 of each shifting stage, e.g., ST_SH2, respectively, and a gate-off voltage Voff may be input to the gate-off voltage terminal Vss. However, the scanning start signal STV, instead of the pre-gate signal output from a previous stage, may be input to the first shifting stage ST_SH1, and the scanning start signal STV, instead of the pre-gate signal output from a next stage, may be input to the last shifting stage ST_SHn+1.

Here, the first clock signal CLK is a gate clock signal CLK, and the second clock signal CLKB is a signal having a phase opposite to the first clock signal. That is, the first and second clock signals CLK and CLKB may have a phase difference of 180 degrees. Alternatively, in order to drive a switching element (not shown) constituting pixels (not shown) of a display panel (not shown), when the first clock signal CLK and the second clock signal CLKB are at high levels, they may be gate-on voltages Von, and when the first clock signal CLK and the second clock signal CLKB are at low levels, they may be gate-off voltages Voff.

The circuit and operation of an ith stage (i is an integer) is described below in further detail with reference to FIGS. 4A to 5.

FIGS. 4A through 4C illustrates one of various stages of the gate-driving circuit shown in FIG. 1, and FIG. 5 is a signal waveform diagram illustrating the operation of the gate-driving circuit shown in FIG. 1.

Referring first to FIG. 4A, the ith stage STi outputting a gate signal Gi from a gate-driving circuit (101 of FIG. 2) includes a shifting stage ST_SHi, an operation stage ST_CLKi, and a selection stage ST_SELi.

As described above, the shifting stage ST_SHi receives a gate clock signal CLK, a pre-gate signal G_PREi−1 outputted from a previous stage, and a pre-gate signal G_PREi+1 outputted from a next stage, and provides the pre-gate signal G_PREi to the operation stage ST_CLKi and the selection stage ST_SELi. The pre-gate signal G_PREi may be a signal derived from the pre-gate signal G_PREi−1 output from the previous stage in response to the gate clock signal CLK.

The operation stage ST_CLKi receives the pre-gate signal G_PREi and the gate clock signal CLK and provides the operation signal G_CLKi. That is, the operation stage ST_CLKi performs an operation with respect to the pre-gate signal G_PREi and the gate clock signal CLK and provides a clock signal to the selection stage ST_SELi. The operation stage ST_CLKi may comprise an AND gate to perform an AND operation with respect to the pre-gate signal G_PREi and the gate clock signal CLK, as shown in FIG. 4B.

The selection stage ST_SELi may output one of the operation signal G_CLKi and the pre-gate signal G_PREi as the gate signal Gi. For example, when the scanning start signal STV is at a high level, the pre-gate signal G_PREi is provided as the gate signal Gi. When the scanning start signal STV is at a low level, the operation signal G_CLKi is provided as the gate signal Gi. Here, there is no limitation in the circuit type of the selection stage ST_SELi as long as it can selectively output either the pre-gate signal G_PREi or the operation signal G_CLKi in response to the scanning start signal STV, and the selection stage ST_SELi may be a multiplexer, as shown in FIG. 4C.

In the following description, the operation of the gate-driving circuit according to an embodiment of the present invention in a case where a high level scanning start signal STV is continuously supplied is described with reference to FIGS. 4A through 5. In the gate-driving circuit according to the first embodiment of the present invention, the respective stages ST₁, ST_CLKi, ST_SELi operate in response to a rising edge in which the gate clock signal CLK goes from a low level to a high level or a falling edge in which the gate clock signal CLK goes from a high level to a low level, but the invention is not limited thereto.

Referring to FIG. 5, at time t1, the scanning start signal STV, which is maintained at a high level, can be supplied. At time t2, a high-level pre-gate signal G_PRE1 can be supplied in the first shifting stage ST_SH1 in synchronization with the gate clock signal CLK. In addition, at time t2, an operation signal G_CLK1, obtained by performing an operation with respect to the pre-gate signal G_PRE1 and the gate clock signal CLK may be supplied in the first operation stage ST_CLK1. In the first selection stage ST_SEL1, the scanning start signal STV is maintained at a high level. Accordingly, the pre-gate signal G_PRE1 can be supplied as a gate signal G1.

Similarly, at time t3, high-level pre-gate signals G_PRE2 and G_PREi can be supplied in the 2nd and ith shifting stages ST_SH2 and ST_SHi, respectively. At time t4, operation signals G_CLK2, G_CLKi can be supplied in the operation stages ST_CLK2 and ST_CLKi, respectively. In the selection stages ST_SEL2 and ST_SELi, the scanning start signal STV is maintained at a high level. Accordingly, the high-level pre-gate signals G_PRE2 and G_PREi can be supplied as gate signals G2 and Gi.

A gate-driving circuit according to a second embodiment of the present invention is described below with reference to FIGS. 2 3, and 6 through 7.

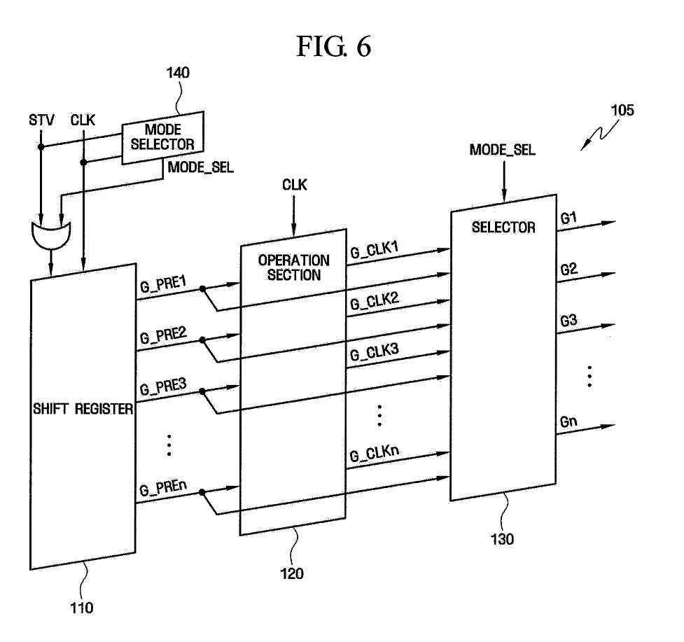

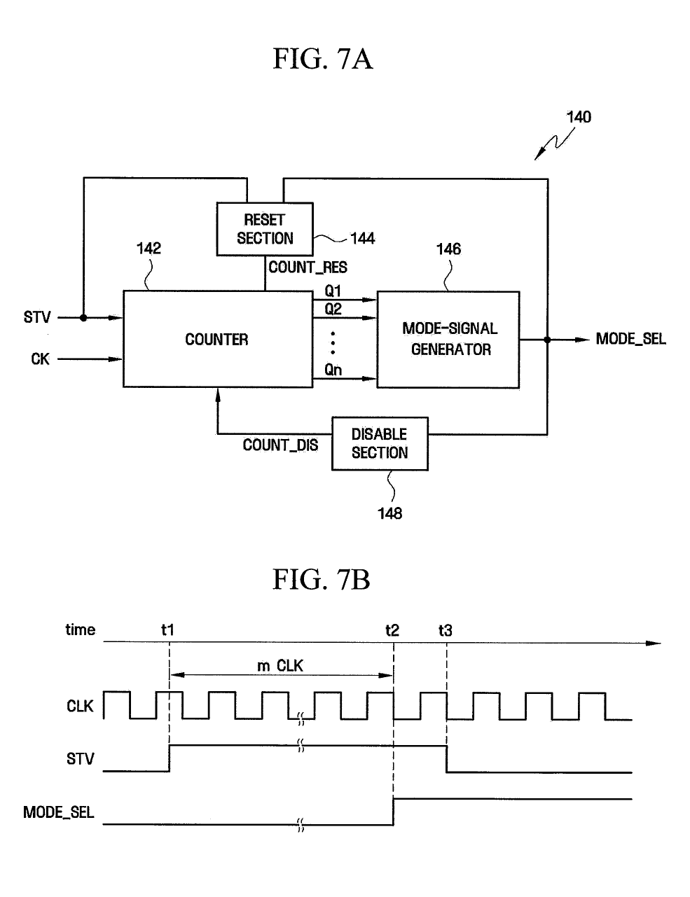

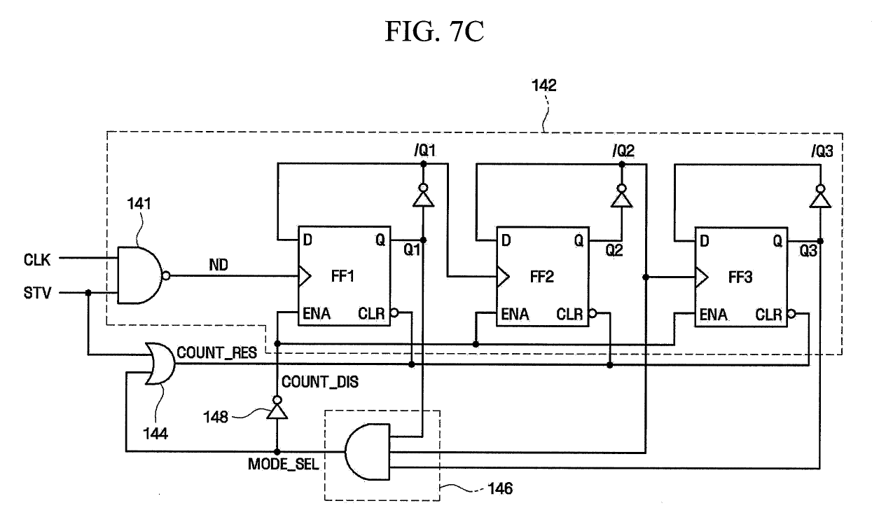

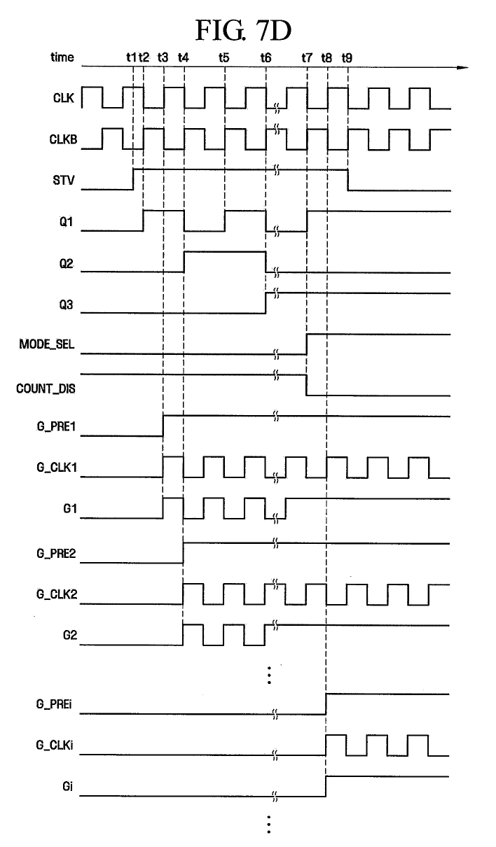

FIG. 6 is a block diagram of a gate-driving circuit according to a second embodiment of the present invention, and FIGS. 7A through 7D are diagrams illustrating a mode selector shown in FIG. 6. For brevity, components each having the same function for describing the embodiments shown in FIGS. 2 and 3 are respectively identified by the same reference numerals and their repetitive description are not repeated.

Referring to FIG. 6, the gate-driving circuit 105 includes a mode selector 140, a shift register 110, an operation section 120, and a selector 130. The mode selector 140 may provide a mode signal MODE_SEL in response to the scanning start signal STV and the gate clock signal CLK.

Referring to FIG. 7A, the mode selector 140 includes a counter 142, a mode-signal generator 146, a disable section 148, and a reset section 144.

The counter 142 receives the scanning start signal STV and the gate clock signal CLK, counts a number of clocks of the gate clock signal CLK while an enabled scanning start signal STV is supplied, and outputs the counting results Q1˜Qn. The counting of the number of clocks of the gate clock signal CLK may be performed in response to a rising edge or a falling edge of the gate clock signal CLK. Here, the counter 142 may be a synchronous counter or an asynchronous counter. In particular, an asynchronous counter is advantageously used from the viewpoint of size.

The mode-signal generator 146 may generate the mode signal MODE_SEL in response to the counting results Q1˜Qn output from the counter 142. For example, when the counting results Q1˜Qn obtained by counting the number of clock cycles of the gate clock signal CLK counted while an enabled scanning start signal STV, e.g., a high-level scanning start signal STV, is supplied, reached m (m is a natural number), the mode-signal generator 146 may provide an enabled mode signal MODE_SEL. Here, m may be an arbitrarily selected natural number, for example, a number of gate lines that can simultaneously apply a gate-on voltage Von to gate lines (not shown) without malfunction of the gate-driving circuit.

The disable section 148 may supply a disabled signal COUNT_DIS to the counter 142. That is, the disable section 148 disables the counter 142 in response to the enabled mode signal MODE_SEL supplied from the mode-signal generator 146, and holds the enabled mode signal MODE_SEL. Here, the enabled mode signal MODE_SEL may be, for example, a high-level mode signal. In detail, the counter 142 may continuously count a number of clock cycles of the gate clock signal CLK in response to the enabled scanning start signal STV and the gate clock signal CLK. Accordingly, when the counting result reaches, for example, m+1, the mode-signal generator 146 may generate the enabled mode signal MODE_SEL. Accordingly, in order to continuously provide the enabled mode signal MODE_SEL after the counting result reaches m, the counter 142 may be disabled.

The reset section 144 resets the counter 142 in response to the scanning start signal STV and the mode signal MODE_SEL. When the number of clock cycles of the gate clock signal CLK counted while the enabled scanning start signal STV is supplied, is not m, the counter 142 may be reset, which is for the purpose of preventing the enabled mode signal MODE_SEL from being supplied even when the enabled scanning start signal STV is supplied during the period of, e.g., m-j clock cycles of the gate clock signal CLK (j is an integer) or when the enabled scanning start signal STV is discontinuously supplied during the period of j clock cycles of the gate clock signal CLK.

The operation of the mode selector 140 is described below in further detail with reference to FIG. 7B. After a high-level scanning start signal STV is continuously supplied at time t1, a high-level mode signal MODE_SEL may be supplied at time t2 in response to an mth clock of the gate clock signal CLK. While the counting illustrated in FIG. 7B is performed in response to a falling edge of the gate clock signal CLK, the invention is not limited thereto and the counting may also be performed in response to a rising edge of the gate clock signal CLK.

An exemplary circuit of a mode selector in a gate-driving circuit according to the second embodiment of the present invention is described below with reference to FIGS. 7C and 7D.

The counter 142 may include an NAND gate 141 and three flip-flops FF1, FF2, and FF3. The NAND gate 141 receives a scanning start signal STV and a gate clock signal CLK, and supplies clock cycles to the first flip-flop FF1. That is, while a high-level scanning start signal STV is supplied, the NAND gate 141 allows the counter 142 to perform counting in response to a falling edge of the gate clock signal CLK. The three flip-flops FF1, FF2, and FF3 may output the counting results Q1, Q2, and Q3 and their inverted results /Q1, /Q2, and /Q3 in response to a signal ND applied from the NAND gate 141. Here, the flip-flops FF1, FF2, and FF3 may be, for example, an S-R flip-flop, a D flip-flop, and a J-K flip-flop.

The mode-signal generator 146 may generate a mode signal MODE_SEL in response to the counting results Q1, Q2, and Q3 output from the counter 142 and their complements /Q1, /Q2, and /Q3. For example, when the number m of clock cycles of the gate clock signal CLK counted, is 5, as shown in FIG. 7B, the mode-signal generator 146 is configured to supply a high-level mode signal. However, the circuit configuration of the mode-signal generator 146 may vary according to the value of m.

The disable section 148 supplies a disable signal COUNT_DIS of the mode signal MODE_SEL to an enable terminal ENA of each of the respective flip-flops FF1, FF2, and FF3, to make the counter 142 interrupt counting of the number of clock cycles. Here, if the counter 142 is disabled in response to the high-level mode signal MODE_SEL, not only an inverter but also other operation circuits can be used.

The reset section 144 may supply a reset signal COUNT_RES to a reset terminal CLR of each of the respective flip-flops FF1, FF2, and FF3 in response to an OR operation result of the scanning start signal STV and the mode signal MODE_SEL. As described above, the reset section 144 can prevent the high-level mode signal MODE_SEL from being supplied even when a high-level scanning start signal STV is not continuously supplied during the period of, for example, 5 clock cycles of the gate clock signal CLK. For example, when a high-level scanning start signal STV is first supplied during the period of 3 clock cycles of the gate clock signal CLK, and a low-level scanning start signal STV is then supplied, the respective flip-flops FF1, FF2, and FF3 may be reset to resume the counting.

The detailed circuit and operation of the gate-driving circuit is described below with reference to FIG. 7D. The gate-driving circuit may perform a first mode operation and a second mode operation according to a mode signal MODE_SEL. In the first mode operation of the gate-driving circuit, for example, a high-level gate signal may be supplied in less than one clock period of the high level gate clock signal CKL in response to a low-level mode signal MODE_SEL. In addition, in the second mode operation of the gate-driving circuit, a high-level gate signal may be supplied in more than one clock period of the high level gate clock signal CKL in response to a high-level mode signal MODE_SEL.

After the high-level scanning start signal STV is supplied at time t1, output values Q1, Q2, and Q3 of the flip-flops FF1, FF2, and FF3 and their complements /Q1, /Q2, and /Q3 may be supplied at times t2, t4, t5, t6, and t7 in response to falling edges of the gate clock signal CLK. The mode selector 146 performs an AND operation on the values Q1, /Q2, and Q3 and supplies the mode signal MODE_SEL. At time t8, Q1, /Q2, and Q3 go high, a high-level mode signal MODE_SEL may be supplied. The disable section 148 inverts the mode signal MODE_SEL and supplies a low-level disable signal COUNT_DIS to an enable terminal ENA of each of the flip-flops FF1, FF2, and FF3, thereby disabling the flip-flops FF1, FF2, and FF3.

At time t3, the first stage ST1 may provide a pre-gate signal G_PRE1 and an operation signal G_CLK1 in response to the gate clock signal CLK. In addition, since the mode signal MODE_SEL is at a low level, the selector 130 provides the operation signal G1 as the gate signal G1. At time t8, when the mode signal MODE_SEL makes a transition to a high level, the pre-gate signal G_PRE1 may be supplied as the gate signal G1.

Similarly, at time t4, the second stage ST2 may provide a pre-gate signal G_PRE2 and an operation signal G_CLK2 in response to the gate clock signal CLK. In addition, since the mode signal MODE_SEL is at a low level, the selector 130 provides the operation signal G2 as the gate signal G2. At time t7, when the mode signal MODE_SEL makes a transition to a high level, the pre-gate signal G_PRE1 may be supplied as the gate signal G2. Further, after the mode signal MODE_SEL makes a transition to a high level (for example, at time t8), the ith stage, which provides a pre-gate signal G_PREi and an operation signal G_CLKi in response to the gate clock signal CLK, may supply the pre-gate signal G_PREi as the gate signal Gi.

Therefore, when a high-level mode signal MODE_SEL is supplied, a gate signal may be supplied as a signal remaining at a high level, rather than a clock-like signal, such as a gate clock signal.

The shift register 110 receives the scanning start signal STV and/or the mode signal MODE_SEL and supplies sequentially a plurality of pre-gate signals G_PRE1˜G_PREn in synchronization with the gate clock signal CLK. That is, in another embodiment of the present invention, unlike in the previous embodiment, the shift register 110 provides the pre-gate signals G_PRE1˜G_PREn in response to the scanning start signal STV and/or the mode signal MODE_SEL.

In detail, for example, an ORed value of the scanning start signal STV and the mode signal MODE_SEL, output from an OR gate, may be supplied to the shift register 110. That is, when the scanning start signal STV or the mode signal MODE_SEL remaining at a high level is supplied, the shift register 110 may provide the plurality of pre-gate signals G_PRE1˜G_PREn remaining a high level. During the period of a given number of clock cycles of the gate clock signal CKL, the mode selector 140 supplies the high-level mode signal MODE_SEL to then supply a high-level scanning start signal STV. In such a case, even if the scanning start signal STV goes low, the output pre-gate signals G_PRE1˜G_PREn may hold a high level (at time t9 of FIG. 7D). Accordingly, the selector 130 may provide high-level gate signals G1˜Gn in response to the high-level mode signal MODE_SEL.

Further, although not shown, in other embodiments of the present invention, the mode signal MODE_SEL may be externally applied to a gate-driving circuit. For example, the mode signal MODE_SEL may be applied to the gate-driving circuit according to the present invention from a timing controller that provides various signals for controlling a display circuit, including scanning start signals, gate clock signals, data clock signals, image signals, and so on.

In alternative embodiments, the mode signal MODE_SEL may also be applied only to a selector, without being applied to a shift register. For example, when a high-level scanning start signal is continuously supplied to the shift register, a high-level gate signal or a clock-like gate signal may be supplied to the selector according to the type of mode signal supplied to the selector.

The display circuit according to still another embodiment of the present invention will be described with reference to FIGS. 1 through 9.

In the following description, the display circuit according to still another embodiment of the present invention will be described using a liquid crystal display. However, it is apparent to those skilled in the art that the invention can also be applied to any display circuit including a display panel having a unit display such as an OLED and applying display signals to a plurality of data lines and a plurality of gate lines.

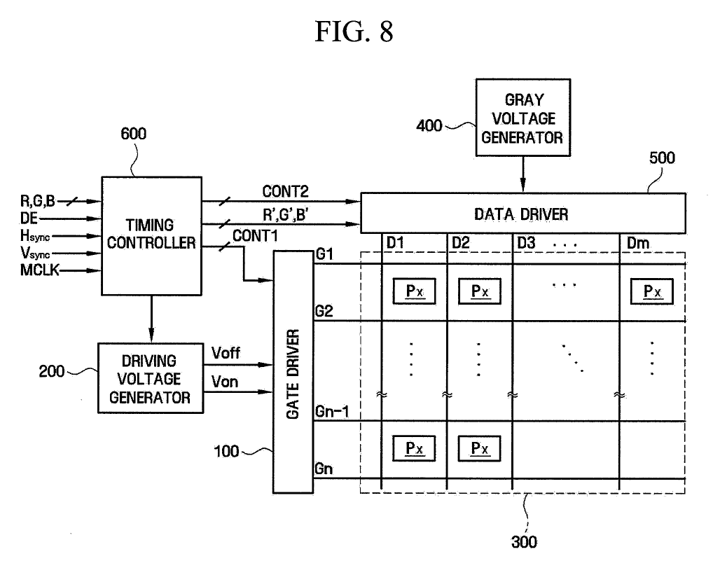

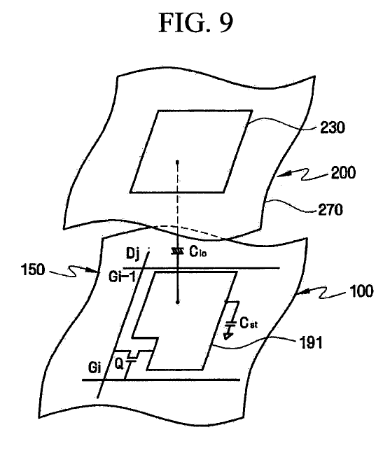

FIG. 8 is a block diagram illustrating a display circuit according to embodiments of the present invention, and FIG. 9 is an equivalent circuit diagram of one pixel in the display circuit shown in FIG. 8.

Referring to FIGS. 8 and 9, the display circuit according to embodiments of the present invention may include a display panel 300, a timing controller 600, a driving voltage generator 200, a gray voltage generator 400, a gate driver 100, and a data driver 500.

As shown in an equivalent circuit of FIG. 1, the display panel 300 includes a plurality of pixels arranged in a matrix and connected to a plurality of display signal lines G1-Gn and D1-Dm.

Here, the plurality of display signal lines G1-Gn and D1-Dm include a plurality of gate lines G1-Gn transmitting gate signals and a plurality of data lines D1-Dm transmitting data signals. The gate lines G1-Gn extend in a column direction and are substantially in parallel with one another and the data lines D1-Dm extend in a row direction and are substantially in parallel with one another. Here, gate signals from the gate-driving circuit 300 are supplied to the corresponding gate lines, and the gate signals and the gate lines are denoted by the same symbols G1-Gn.

Each of the plurality of pixels consists of a switching element Q connected to a corresponding one of the plurality of display signal lines G1-Gn and D1-Dm, a liquid crystal capacitor C_{lc} and a storage capacitor Cₛₜ connected to the switching element Q. The storage capacitor Cₛₜ may not be formed, if necessary.

The driving voltage generator 200 generates a plurality of driving voltages. For example, the driving voltage generator 200 generates a gate-on voltage Von, a gate-off voltage Voff, and a common voltage Vcom.

The data driver 500 is connected to data lines D1-Dm of the display panel 300, and selects a plurality of gray voltages supplied from the gray voltage generator 400 to apply the same to unit pixels as data signals. The data driver 500 is generally composed of a plurality of IC chips.

The gate driver 100 is connected to gate lines G1-Gn of the display panel 300 and externally applies gate signals composed of a combination of gate-on voltage Von and gate-off voltage Voff. The gate driver 100 applies the gate signal Von or Voff to the gate lines G1˜Gn in response to a gate control signal CONT1 supplied from the timing controller 600 to turn on/off switching elements Q connected to the gate lines G1˜Gn. The illustrated display circuit is driven by a single gate driver, but the invention is not limited thereto, and the display circuit according to the present invention can also be driven by a dual gate driver.

In detail, the gate driver 100 may include a shift register sequentially providing n pre-gate signals in response to a scanning start signal STV, an operation section performing operations on the pre-gate signals and a plurality of gate clock signals to then sequentially output a plurality of operation signals, and a selector selectively outputting the plurality of pre-gate signals or the plurality of operation signals in response to the scanning start signal STV. Detailed operations of the gate driver 100 are substantially the same as those described above regarding gate driving circuit 101, and thus any further descriptions thereof is omitted. In addition, the gate driver 100 may be configured in any form of the gate-driving circuits according to the previous embodiments.

While the gate-on voltage Von is applied to one of the gate lines G1˜Gn and the switching element Q of a row connected thereto is turned on, the data driver 500 supplies a data voltage to a corresponding one of the data lines D1˜Dm. The data voltages supplied to the data lines D1˜Dm are applied to the corresponding unit pixels through the turned on switching element Q.

The gray voltage generator 400 generates two sets of (reference) gray voltages related to the transmittance of the unit pixel. One of the two sets of (reference) gray voltages has a positive value relative to the common voltage Vcom, and the other set has a negative value relative to the common voltage Vcom. A positive data voltage and a negative data voltage have opposite polarities with respect to the common voltage Vcom, and are alternately applied to the display panel 300 during inversion driving.

The gate driver 100 or the data driver 500 may be directly mounted on the LC panel assembly 300 in the form of a plurality of driving IC chips, or may be mounted on a flexible printed circuit film (not shown) as a tape carrier package (“TCP”) type, which are attached to the LC panel assembly 300. However, the gate driver 100 or the data driver 500 may also be integrated in the display panel 300 along with the first switching element Q and the signal lines G1˜Gn and D1˜Dm.

The timing controller 600 generates control signals for controlling operations of the gate driver gate driver 100 and the data driver 500, and supplies the corresponding control signals to the gate driver 100 and the data driver 500.

The present invention is described in more detail through the following concrete experimental example. However, the experimental example is for illustrative purposes and other examples and applications can be readily envisioned by a person of ordinary skill in the art. Since a person skilled in the art can sufficiently analogize the technical contents which are not described in the following concrete experimental example, and the description thereof has been omitted.

### EXPERIMENTAL EXAMPLE

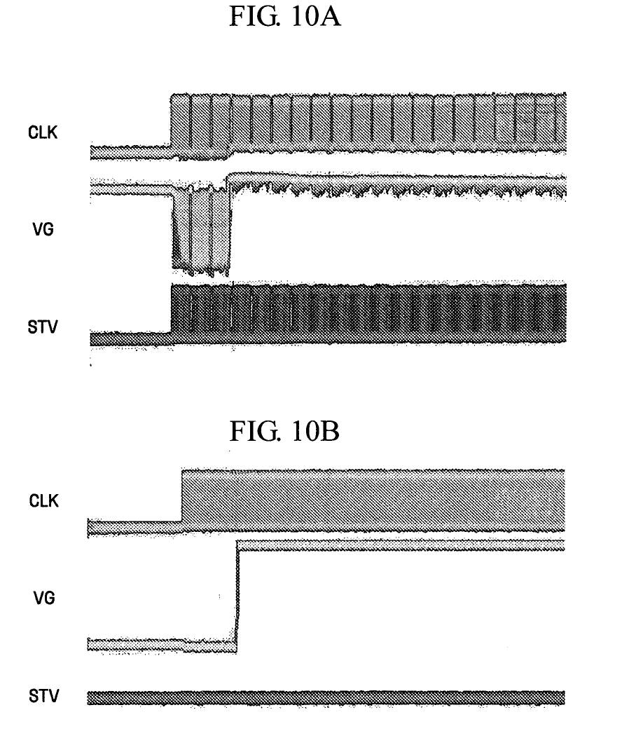

Simulation of gate line voltage measurement was made by continuously supplying a high-level scanning start signal STV to a conventional gate driver and a gate driver according to the present invention, to increase a number of gate lines to which a gate-on voltage Von was simultaneously applied. The simulated results are shown in FIGS. 10A and 10B.

The number of gate lines to which the gate-on voltage Von was simultaneously applied was 10, and voltages of the gate lines were measured. Here, CLK, STV, and VG denote a gate clock signal, a scanning start signal, and a voltage of a gate line, respectively.

Referring to FIGS. 10A and 10B, the gate-on voltage Von was not properly applied to the gate lines of the conventional gate driver, the gate-on voltage Von was properly applied to the gate lines of the gate driver according to the present invention without malfunction. In more detail, the conventional gate driver has a large amount of dynamic current flowing when a gate line makes a transition from a gate-off voltage Voff to a gate-on voltage Von, while having a negligible amount of static current flowing during a gate-on voltage Von state. Thus, the conventional gate driver increases power consumption as the number of gate lines to which the gate-on voltage Von is simultaneously applied increases, resulting in malfunction of the gate driver. In contrast, in the gate driver according to the present invention, since a gate-on voltage Von is applied to the gate lines one by one, power consumption is not high, so that the gate driver operates normally.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A gate-driving circuit comprising:
a shift register that receives a gate clock signal and scanning start signal and/or a mode signal and sequentially provides a plurality of pre-gate signals in synchronization with the gate clock signal;
an operation section that receives the gate clock signal and the plurality of pre-gate signals and performs operations on the plurality of pre-gate signals which includes sequentially outputting a plurality of operation signals; and
a selector receives the plurality of pre-gate signals and the plurality of operation signals and selectively outputs the plurality of pre-gate signals or the plurality of operation signals in response to receipt of the mode signal.

2. The gate-driving circuit of claim 1, wherein the pre-gate signals make transitions from a low level to a high level in response to a high level of the scanning start signal, and maintain a high level while the scanning start signal is at a high level.

3. The gate-driving circuit of claim 1, further comprising a mode selector that provides the mode signal in response to a scanning start signal and the gate clock signal.

4. The gate-driving circuit of claim 3, wherein the mode selector further comprises a counter that counts a number of gate clock signals occurring during a time when the enabled scanning start signal is supplied, and a mode-signal generator that generates an enabled mode signal when the number of clock cycles of the gate clock signal counted is equal to or greater than m, where m is an integer.

5. The gate-driving circuit of claim 4, wherein the counter includes a plurality of flip-flops, and the mode-signal generator performs AND operations on output signals of the plurality of flip-flops and/or inverted output signals.

6. The gate-driving circuit of claim 4, wherein the mode-signal generator further comprises a disable section that supplies a disable signal to the counter in response to the mode signal, and a reset section that resets the counter in response to the scanning start signal and the mode signal.

7. The gate-driving circuit of claim 6, wherein the disable section inverts the mode signal to supply the disable signal,
and the reset section supplies a reset signal obtained by performing an OR operation on the scanning starting signal and the mode signal to the flip-flops.

8. The gate-driving circuit of claim 1, wherein in the first mode operation, a high-level gate signal is supplied in less than one clock period of the high level gate clock signal in response to a low-level mode signal, and in the second mode operation, a high-level gate signal is supplied in more than one clock period of the high level gate clock signal in response to a high-level mode signal.

9. A display device comprising:
a display panel that includes a plurality of unit displays defined at intersections of a plurality of gate lines and a plurality of data lines;
a timing controller that generates various control signals for driving the plurality of unit displays;
a driving voltage generator that receives the control signals and generates a plurality of driving voltages;
a gate driving circuit comprising:
a shift register that receives a scanning start signal and a gate clock signal and/or a mode signal and sequentially provides a plurality of pre-gate signals in synchronization with the gate clock signal;
an operation section that receives the gate clock signal and the plurality of pre-gate signals and performs operations on the plurality of pre-gate signals which includes sequentially outputting a plurality of operation signals; and
a selector receives the plurality of pre-gate signals and the plurality of operation signals and selectively outputs the plurality of pre-gate signals or the plurality of operation signals in response to receipt of the mode signal; and
a data driver that supplies data voltages to the plurality of data lines.

10. The display device of claim 9, further comprising: a mode selector that provides the mode signal to the gate driver in response to a scanning start signal and the gate clock signal.

11. The display device of claim 10, wherein the mode selector further comprises a counter that counts a number of gate clock signals occurring during a time when the enabled scanning start signal is supplied, and a mode-signal generator that generates an enabled mode signal when the number of clock cycles of the gate clock signal counted is equal to or greater than m, where m is an integer.

12. The display device of claim 11, wherein the counter includes a plurality of flip-flops, and the mode-signal generator performs AND operations on output signals of the plurality of flip-flops and/or inverted output signals.

13. The display device of claim 11, wherein the mode-signal generator further comprises a disable section that supplies a disabled signal to the counter in response to the mode signal, and a reset section that resets the counter in response to the scanning start signal and the mode signal.

14. The display device of claim 13, wherein the disable section inverts the mode signal to supply the disabled signal,
and the reset section supplies a reset signal obtained by performing an OR operation on the scanning starting signal and the mode signal to the flip-flops.

15. A method of driving a display device comprising:
providing a shift register with a scanning start signal and/or a mode signal and to sequentially provide a plurality of pre-gate signals in synchronization with a gate clock signal;
providing an operation on the plurality of pre-gate signals and the gate clock signal, respectively, and to sequentially output a plurality of operation signals;
selectively outputting the plurality of pre-gate signals or the plurality of operation signals in response to the mode signal; and
using the pre-gate signals or the operation signals in a display of an image.

16. The method of claim 15, wherein the mode signal is supplied in response to the scanning start signal and the gate clock signal.
